(19) United States
(12) Patent Application Publication
(10) Pub. No.: US 2024/0157479 A1
(43) Pub. Date: May 16, 2024

(54) ADDITIVE MANUFACTURING DEVICE

(71) Applicant: JTEKT CORPORATION, Osaka-shi (JP)

(72) Inventors: Makoto TANO, Obu-shi (JP); Takaya NAGAHAMA, Obu-shi (JP); Koichi SHIIBA, Nisshin-shi (JP); Takashi MIZOGUCHI, Kariya-shi (JP); Kohei KATO, Nagoya-shi (JP); Sho HASEGAWA, Kariya-shi (JP)

(73) Assignee: JTEKT CORPORATION, Osaka-shi (JP)

(21) Appl. No.: 18/422,912

(22) Filed: Jan. 25, 2024

Related U.S. Application Data
(62) Division of application No. 17/137,551, filed on Dec. 30, 2020.

(30) Foreign Application Priority Data
Jan. 10, 2020 (JP) 2020-002751

(51) Int. Cl. B23K 26/342; B22F 10/85; B22F 12/41; B23K 26/00; B23K 26/06; B23K 26/082; B33Y 30/00; B33Y 50/02; B33Y 70/10

(52) U.S. Cl. CPC B23K 26/342; B22F 10/85; B22F 12/41; B23K 26/0006; B23K 26/0608; B23K 26/0613; B23K 26/0626; B23K 26/082; B33Y 30/00; B33Y 50/02; B33Y 70/10; B22F 2301/15; B23K 26/0736

(57) ABSTRACT

An additive manufacturing device includes: an inner light beam radiation device of radiating an inner light beam; an outer light beam radiation device of radiating an outer light beam; and a control device. when a molten pool is irradiated with the outer light beam, the control device controls a power density of the outer light beam representing an output per unit area such that a cooling rate of the molten pool representing a temperature drop per unit time is 540° C./s or less at a freezing point of a carbide binder included in the molten pool, the molten pool being formed by irradiating a material including a hard material and a carbide binder with the inner light beam to melt the material. According to the present disclosure, the additive manufacturing device can prevent cracking and additively manufacture a high-quality shaped object with a simple configuration.

### CROSS-REFERENCE TO RELATED APPLICATIONS

This application is a division of U.S. patent application Ser. No. 17/137,551 filed Dec. 30, 2020, which is based on and claims priority under 35 USC 119 from Japanese Patent Application No. 2020-002751 filed Jan. 10, 2020, the contents of which are incorporated herein by reference.

### TECHNICAL FIELD

The present disclosure relates to an additive manufacturing device.

### BACKGROUND ART

It is known that the additive manufacturing includes, for example, a directed energy deposition method, a powder bed fusion method, and the like. In the directed energy deposition method, the additive manufacturing is performed by controlling a position of a processing head for performing radiation of a light beam (a laser beam, an electron beam, etc.) and supply of a material. The directed energy deposition method includes laser metal deposition (LMD), direct metal printing (DMP), and the like. In the powder bed fusion method, the additive manufacturing is performed by irradiating a powder material, which is spread flat, with a light beam. The powder bed fusion method includes selective laser melting (SLM), electron beam melting (EBM), and the like.

For example, in the LMD of the directed energy deposition method, a powder material containing a hard material is irradiated with a light beam while being ejected, and thereby the powder material can be solidified after being melted. Accordingly, the LMD is used as, for example, an overlay technology of partially adding a shaped object formed of a hard material to a base.

For example, WO2019/069701A1 discloses a cemented carbide composite material. A cemented carbide composite material according to the related art includes a cemented carbide part containing tungsten carbide (WC) and cobalt (Co), and a base material part containing nickel (Ni) or cobalt (Co), and includes an intermediate layer between the cemented carbide part and the base material part, which contains a component of the cemented carbide part and a component of the base material part.

In the additive manufacturing, a powder material is solidified after being melted, thereby manufacturing a shaped object. In a situation in which a powder material containing a hard material is solidified from a molten state by rapid cooling, cracking may occur in the shaped object due to the toughness of the hard material, and the quality of a hard shaped object is reduced. In this case, rapid cooling can be prevented by preheating the powder material.

However, for example, a material powder is ejected to partially add a shaped object to bases having various shapes in the LMD, and thus, a method of preheating a powder material using a part of an additive manufacturing device such as a base plate, like the SLM, is not practical. Although it is also conceivable to preheat the powder material using a heater or the like in the LMD, the processing head may be interfered or a control system may be complicated.

### SUMMARY OF INVENTION

The present disclosure provides an additive manufacturing device that can prevent cracking and additively manufacture a high-quality shaped object with a simple configuration.

According to an aspect of the present disclosure, an additive manufacturing device includes: an inner light beam radiation device configured to radiate an inner light beam that heats a material at a temperature equal to or higher than a melting point of the material, the material including a hard material and a carbide binder; an outer light beam radiation device configured to radiate an outer light beam that heats the material at a temperature lower than the melting point in an outside of the inner light beam; and a control device configured to control radiations of the inner light beam and the outer light beam, and to control each movement of the inner light beam and the outer light beam relative to a base, for each of the inner light beam radiation device and the outer light beam radiation device. When a molten pool is irradiated with the outer light beam, the control device controls a power density of the outer light beam representing an output per unit area such that a cooling rate of the molten pool representing a temperature drop per unit time is 540° C./s or less at a freezing point of the carbide binder included in the molten pool, the molten pool being formed by irradiating the material with the inner light beam to melt the material.

Accordingly, when the molten pool, which is formed by melting a material including a hard material by means of radiating the inner light beam, is irradiated with the outer light beam, the control device can control the power density of the outer light beam so that the cooling rate in the cooling of the molten pool is 540° C./s or less at the freezing point of the carbide binder included in the molten pool.

In this way, the power density of the outer light beam is controlled to perform the heat retention treatment, so that the cooling rate of the molten pool (a shaped object) is 540° C./s or less. Thus, rapid cooling and solidification of the shaped object can be prevented. Therefore, with a simple configuration, the occurrence of cracking of the shaped object can be prevented, and a high-quality shaped object can be additively manufactured.

### BRIEF DESCRIPTION OF DRAWINGS

FIG. 1 is a diagram showing an additive manufacturing device.

FIG. 2 is a perspective view illustrating a base for additively manufacturing a shaped object by the additive manufacturing device of FIG. 1.

FIG. 3 is a view of the base in FIG. 2, to which a shaped object is added, as viewed from a central axis direction.

FIG. 4 is a cross-sectional view illustrating an initial state of a shaped object added to a base when the shaped object manufactured by the additive manufacturing device of FIG. 1 is additively manufactured.

FIG. 5 is a cross-sectional view illustrating an intermediate state and an additional state of the shaped object additively manufactured to the base when movement is advanced from the state of FIG. 4 to an extent.

FIG. 6 is a beam profile showing a relation between a power density and a light radiation range in a case of additively manufacturing a shaped object on a base in the additive manufacturing device of FIG. 1.

FIG. 7 is a graph showing a relation between preheating temperature and the number of crackings in a shaped object.

FIG. 8 is a graph for showing a cooling rate at a freezing point of cobalt (Co), which is a carbide binder.

FIG. 9 is a diagram for showing a size of a diameter of an inner light beam and a size of a diameter of an outer light beam.

FIG. 10 is a graph for showing a change in a cooling rate in a case where a ratio of the diameter of the outer light beam to the diameter of the inner light beam is changed.

FIG. 11 is a beam profile showing a relation between a power density and a light radiation range according to a first alternative embodiment.

FIG. 12 is a graph showing a relation between a light radiation shape of an outer light beam and a beam profile according to a second alternative embodiment.

FIG. 13 is a graph for showing a case where a beam profile is changed in accordance with a light radiation shape of an outer light beam according to a third alternative embodiment.

FIG. 14 is a graph for showing a case where a beam profile is changed in accordance with a light radiation shape of an outer light beam according to a third alternative embodiment.

FIG. 15 is a diagram showing another configuration of a light radiation device applied to an additive manufacturing device.

FIG. 16 is a diagram showing another configuration of a light radiation device applied to an additive manufacturing device.

### DESCRIPTION OF EMBODIMENTS

### 1. Overview of Additive Manufacturing Device

An additive manufacturing device of the present embodiment adopts, for example, an LMD method that is a directed energy deposition method. In the present embodiment, the additive manufacturing device additively manufactures a hard shaped object at a base by radiating a light beam while ejecting a powder material, which is obtained by mixing a bonded powder material with a hard powder material that is a hard material, to the base. The powder material, particularly the hard powder material, and the base, may be formed of different materials, or may be formed of the same material.

In the present embodiment, a case where a hard shaped object to be shaped using a hard powder material of tungsten carbide (WC), which is a hard material, is additively manufactured to a base formed using carbon steel (S45C) will be described. Here, cobalt (Co) that acts as a carbide binder for bonding tungsten carbide (WC) to each other is used as the bonded powder material. Here, a melting point (freezing point) of tungsten carbide (WC) is 2870° C., which is higher than a melting point (freezing point) of cobalt (Co) as a carbide binder of 1495° C. In the present embodiment, cobalt (Co) is used as the carbide binder. However, the carbide binder is not limited to cobalt (Co), and, for example, nickel (Ni) can also be used as a carbide binder.

### 2. Configuration of Additive Manufacturing Device 100

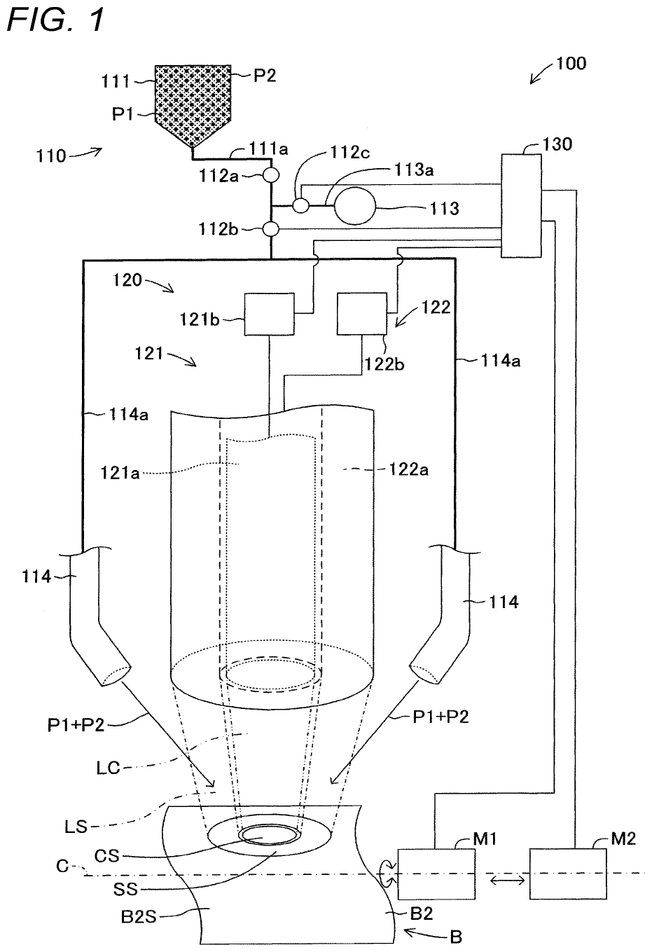

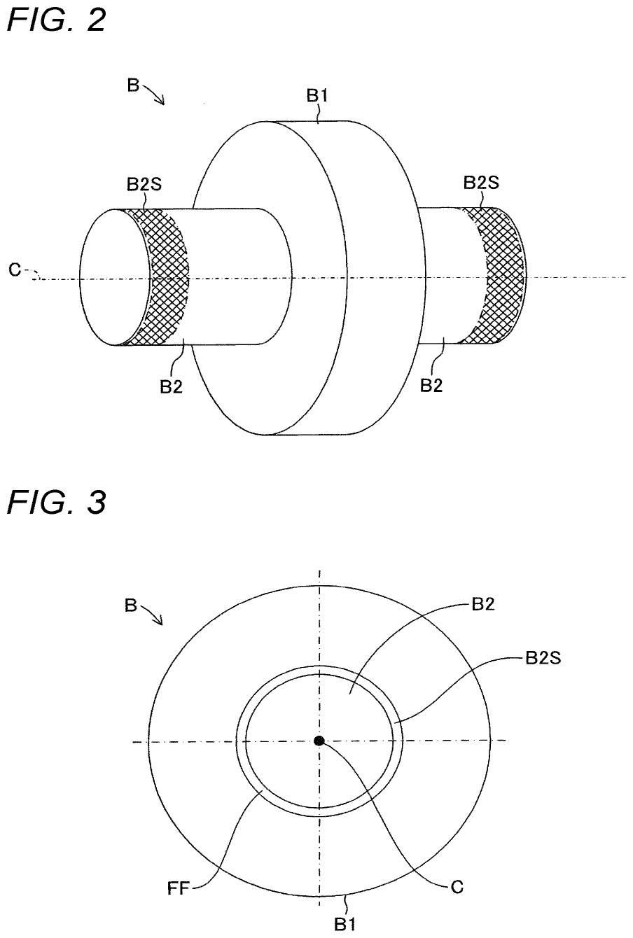

As shown in FIG. 1, the additive manufacturing device 100 mainly includes an additive material supply device 110, a light beam radiation device 120, and a control device 130. Here, as shown in FIGS. 2 and 3, the present embodiment illustrates a case where the additive manufacturing device 100 additively manufactures a shaped object FF at a base B that has a shape in which small-diameter cylindrical members B2, B2 are coaxially integrated on both side surfaces of a large-diameter disk member B1. Specifically, the additive manufacturing device 100 additively manufactures the shaped object FF at circumferential surfaces (a support portion of a rolling bearing not shown) B2S, B2S indicated by grids on open end sides of the cylindrical members B2, B2 of the base B.

As shown in FIG. 1, when the shaped object FF is additively manufactured to the base B, the additive manufacturing device 100 rotates a motor M1 to rotate the base B around a central axis C. Further, the additive manufacturing device 100 rotates a motor M2 to move the base B in a direction of the central axis C. Accordingly, the shaped object FF can be additively manufactured in layers over the entire circumferential surfaces B2S, B2S of the cylindrical members B2, B2.

The additive material supply device 110 includes a hopper 111, a valve 112, a gas cylinder 113, and ejection nozzles 114. The hopper 111 stores a hard powder material P1 mixed with a bonded powder material P2. In the present embodiment, since the shaped object FF is formed of a large number of the hard powder material P1 and a small number of the bonded powder material P2, the amount of the bonded powder material P2 mixed with the hard powder material P1 is the amount corresponding to the bonded powder material P2 in the shaped object FF.

The valve 112 includes a powder introduction valve 112a, a powder supply valve 112b, and a gas introduction valve 112c. The powder introduction valve 112a is connected to the hopper 111 via a pipe 111a. The powder supply valve 112b is connected to each of the ejection nozzles 114 via a pipe 114a. The gas introduction valve 112c is connected to the gas cylinder 113 via a pipe 113a.

The injection nozzle 114 ejects and supplies the hard powder material P1 and the bonded powder material P2 to the circumferential surfaces B2S of the cylindrical members B2 of the base B by, for example, a high-pressure nitrogen gas supplied from the gas cylinder 113. The present embodiment shows a case where two ejection nozzles 114 are disposed with 180 degrees apart. Alternatively, a configuration in which the additive material supply device includes one ejection nozzle 114 or three or more ejection nozzles 114 disposed at equal intervals may be used. Alternatively, a configuration in which the ejection nozzle 114 includes an annular ejection hole that is disposed around a radiation hole irradiated with a light beam by the light beam radiation device 120 may be used. The gas for ejecting the hard powder material P1 and the bonded powder material P2 is not limited to the nitrogen gas, and may be an inert gas such as an argon gas.

The light beam radiation device 120 mainly includes an inner light beam radiation device 121 and an outer light beam radiation device 122. The inner light beam radiation device 121 mainly includes an inner light beam radiation unit 121a and an inner light beam light source 121b. The outer light beam radiation device 122 mainly includes an outer light beam radiation unit 122a and an outer light beam light source 122b.

The inner light beam radiation device 121 radiates an inner light beam LC to the circumferential surfaces B2S of the base B from the inner light beam light source 121b through a collimator lens or a condenser lens (not shown) disposed in the inner light beam radiation unit 121a. The outer light beam radiation device 122 radiates an outer light beam LS to the circumferential surfaces B2S of the base B from the outer light beam light source 122b through a collimator lens or a condenser lens (not shown) disposed in the outer light beam radiation unit 122a.

Here, the inner light beam radiation device 121 radiates the inner light beam LC formed in a circular radiation shape (an inner light radiation range CS) in the present embodiment. The outer light beam radiation device 122 radiates the outer light beam LS formed in an annular radiation shape (an outer light radiation range SS) that is coaxial with the inner light beam LC and surrounds an outer periphery thereof. The inner light beam LC mainly melts the hard powder material P1 and the bonded powder material P2 on the circumferential surfaces B2S of the base B to additively manufacture the shaped object FF. The outer light beam LS mainly prevents drop of temperature of a shaped object FF (more specifically, a molten pool MP to be described below) additively manufactured to the circumferential surfaces B2S of the base B, that is, retains the heat of the shaped object FF. In the present embodiment, laser light is used as the inner light beam LC and the outer light beam LS. However, the inner light beam LC and the outer light beam LS are not limited to the laser light, and, for example, an electron beam may also be used as long as it is an electromagnetic wave.

In the present embodiment, the circular inner light beam LC and the annular outer light beam LS are radiated, and the inner light beam LC and the outer light beam LS are not limited to a circular shape. For example, each of the inner light beam LC and the outer light beam LS may have a quadrilateral shape, or a combination in which the inner light beam LC may have a circular or quadrilateral shape, and the outer light beam LS may have a quadrilateral or circular shape may be used.

The control device 130 controls powder supply of the additive material supply device 110. Specifically, the control device 130 controls opening and closing of the powder supply valve 112b and the gas introduction valve 112c to control the ejection supply of the hard powder material P1 and the bonded powder material P2 from the ejection nozzle 114.

The control device 130 controls light radiation of the light beam radiation device 120, that is, the light beam radiation device 121 and the outer light beam radiation device 122. The control device 130 controls movement with the inner light beam LC and the outer light beam LS relative to the circumferential surfaces B2S of the base B. Specifically, the control device 130 controls rotation of the motor M1 to rotate the base B around the central axis C, and controls rotation of the motor M2 to move the base B in the direction of the central axis C. Accordingly, the movement with the inner light beam LC and the outer light beam LS relative to the circumferential surfaces B2S of the base B is controlled.

In the present embodiment, the control device 130 rotates and moves the base B. However, it is needless to say that the light beam radiation device 120, that is, the inner light beam radiation device 121 and the outer light beam radiation device 122 can be moved relative to the base B.

The control device 130 controls operations of the inner light beam light source 121b and the outer light beam light source 122b, respectively. Accordingly, the control device 130 independently controls output conditions of the inner light beam LC and the outer light beam LS, respectively. Here, examples of the output conditions include a distribution shape of a power density that is a laser output of each of the inner light beam LC and the outer light beam LS, or a laser output (W) per unit area of the inner light radiation range CS and the outer light radiation range SS, that is, a beam profile.

(2-2. Additive Manufacturing Method of Shaped Object FF)

Next, an additive manufacturing method of the shaped object FF will be described. In the additive manufacturing method of the shaped object FF, as a first stage, an initial preheating treatment is performed as a pretreatment in an additive manufacturing treatment of the shaped object FF by the outer light beam LS. In a state where temperature of the circumferential surfaces B2S of the base B is low, thermal energy caused by laser radiation easily escapes to the base B. Accordingly, in a case where the shaped object FF is additively manufactured to the base B in a second stage, occurrence of spatter or the like tends to cause poor melting, and thus, the circumferential surfaces B2S of the base B are preheated in the first stage. At this time, the laser outputs of the inner light beam LC and the outer light beam LS in the initial preheating treatment are controlled so that the circumferential surfaces B2S of the base B reach a predetermined temperature without being melted. In the additive manufacturing, the first stage may also be omitted as necessary.

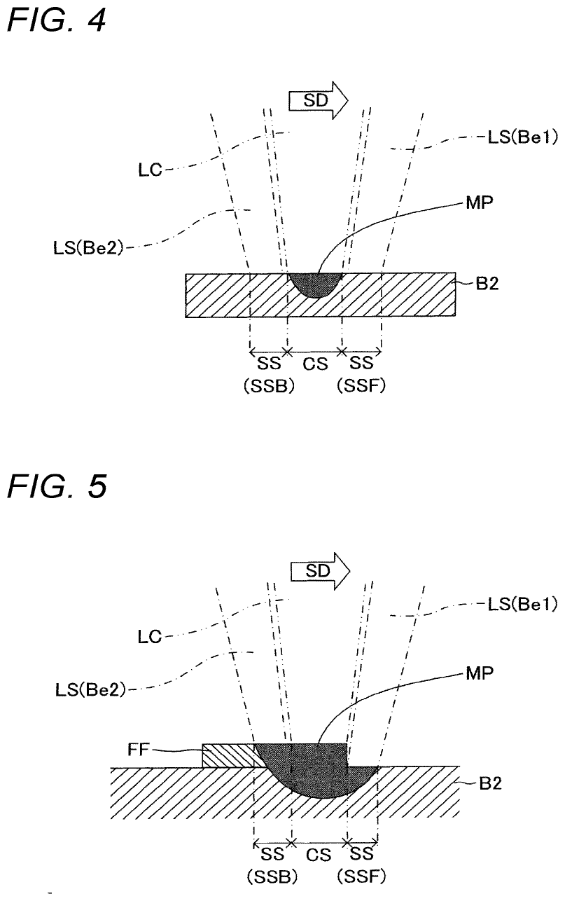

Next, as the second stage, as shown in FIG. 4, a melting treatment of forming a molten pool MP by melting the circumferential surfaces B2S of the base B and the hard powder material P1 in the inner light radiation range CS by means of radiating the inner light beam LC is performed. In the melting treatment, a preheating treatment as a pretreatment of the formation treatment of the molten pool MP is performed by a first light beam Be1, which is a part of the outer light beam LS, within a front radiation range SSF of the outer light radiation range SS of the outer light beam LS in a movement direction SD.

Then, as shown in FIG. 5, the molten pool MP is expanded by performing movement with the inner light beam LC in the movement direction SD in which movement is performed (the base B is rotated and scanned in the present embodiment, but in convenience, it will be described as movement being performed with the inner light beam LC in FIG. 5), so that the shaped object FF is additively manufactured. Here, tungsten carbide (WC) as the hard powder material P1 is bonded with cobalt (Co) as the bonded powder material P2 that acts as a binder, so that the shaped object FF is partially added to the base B.

The inner light beam LC is sequentially moved in the movement direction SD after melting the hard powder material P1 and the bonded powder material P2 so as to expand the molten pool MP. Therefore, the molten pool MP is irradiated with a second light beam Be2, which is a part of the outer light beam LS, within a rear radiation range SSB of the outer light radiation range SS of the outer light beam LS in the movement direction SD. Accordingly, the second light beam Be2 performs a heat retention treatment as a post-treatment of the additive manufacturing of the shaped object FF.

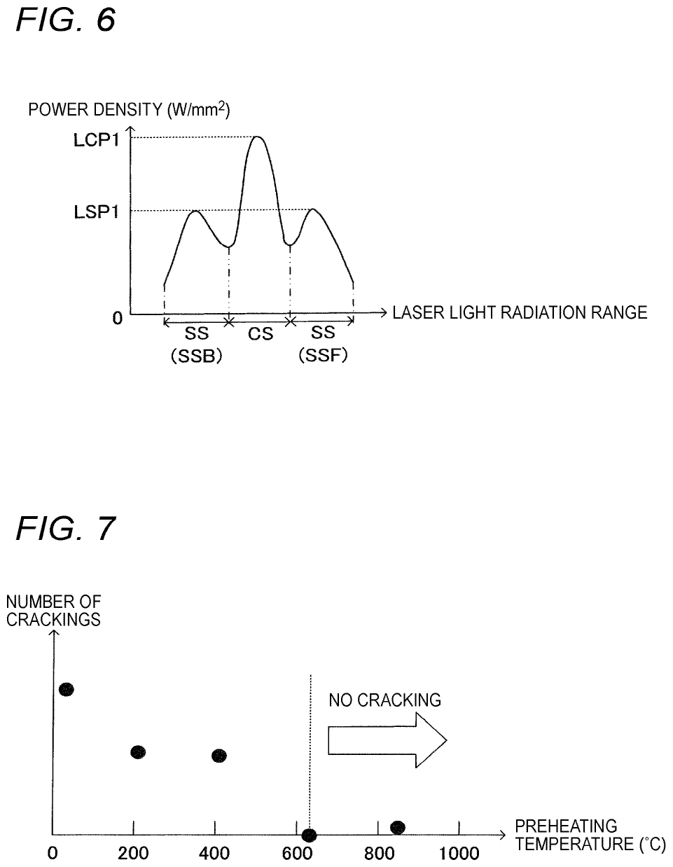

At this time, as shown in FIG. 6, the control device 130 performs control to increase a peak LCP1 of a beam profile of a power density of the inner light beam LC from a peak LSP1 of a beam profile of a power density of the outer light beam LS. A laser output of the inner light beam LC is controlled so that temperature, at which the hard powder material P1 and the bonded powder material P2 are melted and the molten pool MP can be formed, is reached. A laser output of the outer light beam LS, that is, the first light beam Be1 and the second light beam Be2, is controlled so that a predetermined temperature, at which the hard powder material P1 and the bonded powder material P2 are not melted, is reached.

### 3. Heat Retention Treatment Performed by Outer Light Beam LS (Second Light Beam Be2)

Here, the heat retention treatment of the shaped object FF, which is performed by the second light beam Be2, will be described in detail. Cobalt (Co), which is the bonded powder material P2, acts as a binder for bonding tungsten carbide (WC), which is the hard powder material P1. That is, when the molten pool MP transforms from a molten state to a solidified state in the additive manufacturing, cobalt (Co) bonds the particles of tungsten carbide (WC) as a binder. In order to prevent cracking of the shaped object FF by causing cobalt (Co) to act as a binder, it is necessary to appropriately manage temperature drop per unit time, that is, a cooling rate when cobalt (Co) is cooled from a freezing point (in other words, about 1500° C. that is a melting point), and perform the heat retention treatment.

(3-1. Cooling Rate)

The inventors have repeatedly conducted various preliminary experiments, and as a result, they have found a cooling rate (° C./s) at which the cracking of the shaped object FF is prevented after the heat retention treatment by causing cobalt (Co) of the bonded powder material P2 to appropriately act as a binder. This will be specifically described below.

As described above, when the shaped object FF including a hard material such as tungsten carbide (WC) is rapidly cooled after the additive manufacturing, toughness is low. As a result, cracking is likely to occur. Therefore, when the shaped object FF is additively manufactured to the base B by the LMD, it is effective to perform the heat retention treatment to prevent rapid cooling of the shaped object FF. Here, the inventors have conducted preliminary experiments to confirm an effect of rapid cooling on the occurrence of cracking of the shaped object FF. Specifically, the inventors have preheated (heated) the hard powder material P1 and the bonded powder material P2 that includes cobalt (Co) to various temperatures so as to cause degrees of rapid cooling from 1500° C. or higher, at which cobalt (Co) is melted, to be different, and have confirmed presence or absence of cracking of the shaped object FF. As a result, as shown in FIG. 7, when a preheating temperature (heating temperature) is lower than 600° C., that is, in a case where the degree of rapid cooling from the freezing point is high, it has been confirmed that cracking occurs at the shaped object FF. When a preheating temperature (heating temperature) is equal to or higher than 600° C., that is, in a case where the degree of rapid cooling from the freezing point is low, it has been confirmed that cracking does not occur at the shaped object FF.

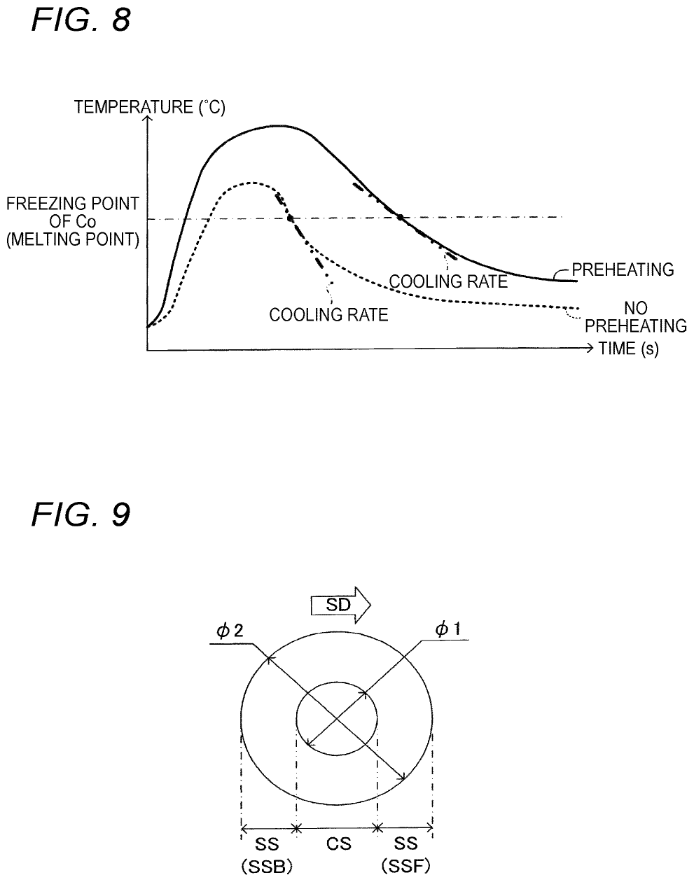

As shown in FIG. 8 that is a diagram of time changes of temperature of the shaped object FF, in a case where preheating of a material including cobalt (Co) is not performed (indicated by a broken line in FIG. 8), the temperature of the shaped object FF decreases rapidly after being heated to exceed a freezing point, i.e., a melting point of cobalt (Co). That is, in a case where the preheating is not performed, thermal energy applied in advance is relatively small after the solidification. Therefore, as indicated by a thick two-dot chain line in FIG. 8, a cooling rate (° C./s) at the freezing point of cobalt (Co), that is, a slope of a tangent at the freezing point of cobalt (Co) increases.

On the other hand, in a case where the material including cobalt (Co) is preheated and the preheating temperature (heating temperature) is equal to or higher than 600° C. (indicated by a solid line in FIG. 8), the temperature of the shaped object FF decreases gradually after being heated to exceed the freezing point, i.e., the melting point of cobalt (Co). That is, in a case where preheating is performed, the thermal energy applied in advance after the solidification is relatively large. Therefore, as indicated by a thick two-dot chain line in FIG. 8, a cooling rate (° C./s) at the freezing point of cobalt (Co) is smaller than the cooling rate in the case where preheating is not performed.

From this, the inventors have found that cracking of the shaped object FF can be prevented by appropriately setting the cooling rate (° C./s) at the freezing point of cobalt (Co) of the bonded powder material P2. Then, the inventors have conducted various experiments for specifying an optimum cooling rate (° C./s) at the freezing point (about 1500° C., more specifically, 1495° C.) of cobalt (Co). As a result, it has been found that, in a case where heat retention is performed so that the cooling rate (° C./s) at the freezing point of cobalt (Co) is 540° C./s or less, rapid cooling of the shaped object FF is prevented, and cracking of the shaped object FF does not occur.

On the basis of this, the control device 130 sets the beam profile of the power density of the outer light beam LS so that a cooling rate is 540° C./s or less, and controls the operation of the outer light beam radiation device 122. Accordingly, in the outer light radiation range SS within which the outer light beam LS is radiated, a cooling rate of 540° C./s or less is reached, in other words, heat retention is performed in a state of being equal to or higher than 600° C., and the rapid cooling is prevented. As a result, cracking of the shaped object FF can be prevented.

(3-2. Size of Outer Light Radiation Range SS)

As described above, the control device 130 sets the beam profile of the power density of the outer light beam LS, in other words, sets the cooling rate at the freezing point of cobalt (Co) to 540° C./s or less within the outer light radiation range SS. When time during which the molten pool MP solidified by the cooling is included in the outer light radiation range SS is reduced even in the case where the cooling rate is set in the above manner, the molten pool MP, that is, the shaped object FF may be rapidly cooled as a result.

Therefore, the inventors have set the cooling rate to 540° C./s or less and assumed a movement speed of a light beam toward the movement direction SD as appropriate. In this case, a size of an optimum outer light radiation range SS has been specified. As shown in FIG. 9, in the present embodiment, the outer light radiation range SS within which the outer light beam LS is radiated is arranged concentrically relative to the circular inner light radiation range CS within which the circular inner light beam LC is radiated. As shown in FIG. 9 herein, a diameter corresponding to a length of the inner light beam LC in the movement direction SD within the inner light radiation range CS formed by the inner light beam LC is defined as a diameter φ1, and a diameter corresponding to a length of the outer light beam LS in the movement direction SD within the outer light radiation range SS formed by the outer light beam LS is defined as a diameter φ2. The diameter of each of the inner light radiation range CS and the outer light radiation range SS is also referred to as “beam spot diameter”.

In a case where movement is integrally performed with the inner light beam LC and the outer light beam LS toward the movement direction SD, and the movement speed is high, the molten pool MP corresponding to the inner light radiation range CS relatively moves to an outside of the outer light radiation range SS rapidly toward a side opposite to the movement direction SD in FIG. 9. Therefore, the time during which the molten pool MP exists inside the outer light radiation range SS is reduced in this case, so that heat retention time is reduced. On the other hand, in a case where the movement speed is low, the molten pool MP moves relatively toward the side opposite to the movement direction SD, but the heat retention time is increased since the time to exist inside the outer light radiation range SS is increased.

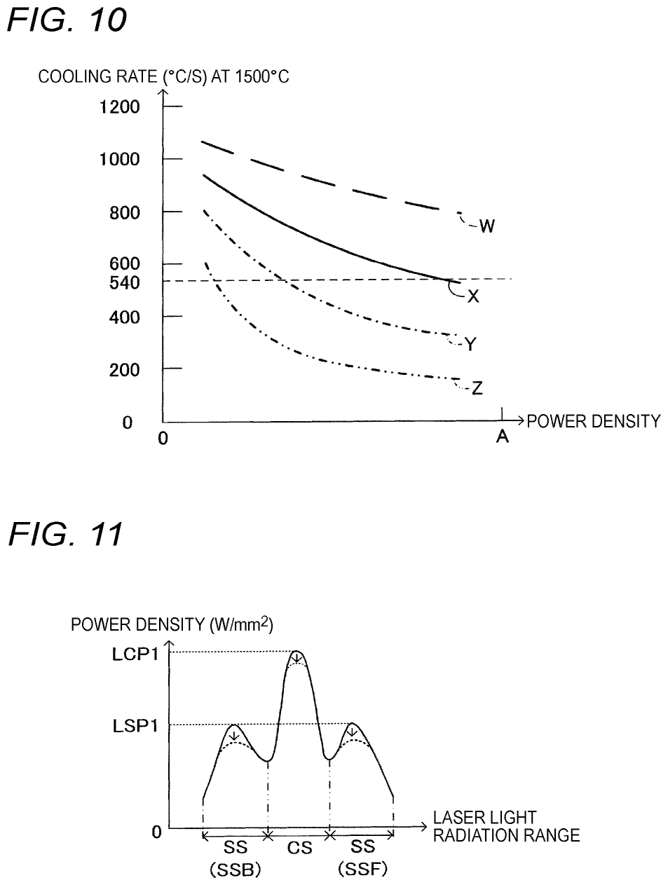

Here, for example, the inventors have assumed a case where the movement speed is set to a speed set in normal additive manufacturing, and made a ratio α of the diameterφ2 of the outer light radiation range SS to the diameter φ1 of the inner light radiation range CS to be different. Then, the inventors have experimentally confirmed a ratio α that satisfies the cooling rate of 540° C./s or less in the molten pool MP in the case where the ratio α is made different. As a result, as indicated by a thick broken line in FIG. 10, the cooling rate of 540° C./s or less cannot be satisfied even if the power density of the outer light beam LS is changed, for example, in a case of “W” in which a value of the ratio α is 1.2 (the diameter φ2 is equivalent to 1.2 times the diameter φ1).

A power density “A” shown in FIG. 10 is a power density at which the hard powder material P1 and the bonded powder material P2 can be melted by being heated to a temperature that is equal to or higher than a melting point. That is, a power density lower than “A” is a power density at which the hard powder material P1 and the bonded powder material P2 are not melted only by being heated to a temperature that is lower than the melting point.

On the other hand, as indicated by a solid line in FIG. 10, the diameter φ2 of the outer light radiation range SS is increased, for example, in a case of “X” in which a value of the ratio α is 1.5 (the diameter φ2 is equivalent to 1.5 times the diameter φ1), as compared with the case of “W”. Accordingly, in the case of “X”, the cooling rate of 540° C./s or less is satisfied. However, in the case of “X”, it is necessary to increase the power density of the outer light beam LS to approach “A”. Accordingly, in a state where the cooling rate of 540° C./s or less at the freezing point of cobalt (Co) is satisfied, the molten pool MP, that is, the shaped object FF can be subjected to the heat retention treatment. Therefore, cracking of the shaped object FF can be prevented.

As indicated by a one-dot chain line in FIG. 10, the diameter φ2 of the outer light radiation range SS is further increased, for example, in a case of “Y” in which a value of the ratio α is 2.0 (the diameter φ2 is equivalent to 2 times the diameter φ1), as compared with the case of “X”. Therefore, in the case of “Y”, the time during which the molten pool MP (the shaped object FF) exists in the outer light radiation range SS is relatively increased. Therefore, in the case of “Y”, even if the power density of the outer light beam LS is relatively low, the molten pool MP (the shaped object FF) can be subjected to the heat retention treatment in a state where the cooling rate of 540° C./s or less is satisfied. That is, cracking of the shaped object FF can be prevented.

Further, as indicated by a two-dot chain line in FIG. 10, the diameter φ2 of the outer light radiation range SS is furthermore increased, for example, in a case of “Z” in which a value of the ratio α is 3.0 (the diameter φ2 is equivalent to 3 times the diameter φ1), as compared with the case of “Y”. Therefore, in the case of “Z”, the time during which the molten pool MP (the shaped object FF) exists in the outer light radiation range SS is furthermore increased. Therefore, in the case of “Z”, even if the power density of the outer light beam LS is relatively low, the molten pool MP (the shaped object FF) can be subjected to the heat retention treatment in a state where the cooling rate of 540° C./s or less is satisfied. That is, cracking of the shaped object FF can be prevented.

On the basis of these findings, the cooling rate at the freezing point of cobalt (Co) included in the molten pool MP is 540° C./s or less in the heat retention treatment of the molten pool MP (the shaped object FF) in the present embodiment. In the present embodiment, a size of the outer light radiation range SS is set such that the diameter φ2 of the outer light radiation range SS is 1.5 times or more than the diameter φ1 of the inner light radiation range CS in the heat retention treatment of the molten pool MP (the shaped object FF). The control device 130 sets the beam profile of the power density of the outer light beam LS and performs the heat retention treatment of the molten pool MP (the shaped object FF) to satisfy these conditions.

### 4. Effects of Present Embodiment

According to the present embodiment described above, the control device 130 can control the beam profile of the power density of the outer light beam LS so that the cooling rate (° C./s) of the molten pool MP is 540° C./s or less at the freezing point of cobalt (Co) included in the molten pool MP when the molten pool MP, formed by melting the hard powder material P1 and the bonded powder material P2 through the radiation of the inner light beam LC, is irradiated with the outer light beam LS.

In this way, the beam profile of the outer light beam LS is set, and the outer light beam radiation device 122 is controlled to perform the heat retention treatment so that the cooling rate of the molten pool MP (the shaped object FF) is 540° C./s or less. Thus, rapid cooling and solidification of the shaped object FF can be prevented. Therefore, with a simple configuration, the occurrence of cracking of the shaped object FF can be prevented, and a high-quality shaped object FF can be additively manufactured.

### 5. First Alternative Embodiment of Present Embodiment

For example, in a case where the shaped object FF is additively manufactured in layers repeatedly, the temperature of the base B or the shaped object FF may rise due to repeated radiation of the inner light beam LC and the outer light beam LS. As described above, since the heat of the molten pool MP (the shaped object FF) is appropriately retained, cracking of the shaped object FF can be prevented. Therefore, in the first alternative embodiment, for example, at least the peak LSP1 of the beam profile of the power density of the outer light beam LS is decreased, in accordance with temperature detected by the control device 130, based on the temperature of the base B or the shaped object FF detected by a radiation thermometer or the like.

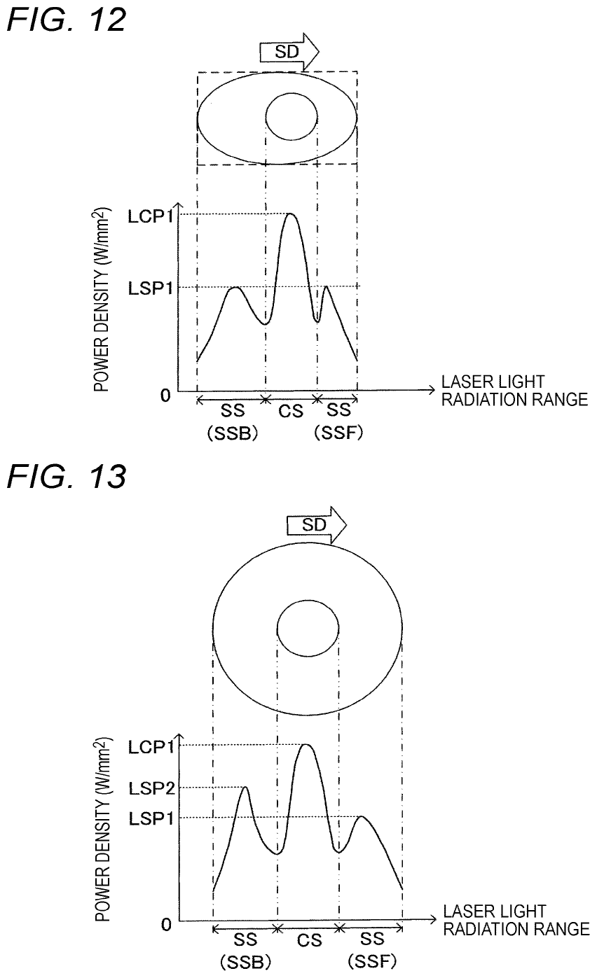

Namely, in the first alternative embodiment, the peak LSP1 of the power density of the outer light beam LS is decreased as shown in FIG. 11 in a case where the base B or the shaped object FF is preheated (heated) as a result of repetition of additive manufacturing. Also in this case, similarly to the present embodiment described above, the cooling rate of 540° C./s or less at the freezing point of cobalt (Co) is satisfied in the molten pool MP, and cracking of the shaped object FF can be prevented. In this case, energy required for the additive manufacturing can be reduced, and thus, manufacturing cost required for the additive manufacturing can be reduced.

### 6. Second Alternative Embodiment of Present Embodiment

In the present embodiment described above, the outer light radiation range SS has a circular shape, and the outer light radiation range SS is concentric with the inner light radiation range CS. Alternatively, in the second alternative embodiment, for example, a shape of the outer light radiation range SS is an elliptical shape having a major axis in a direction along the movement direction SD as shown in FIG. 12 by appropriately setting an optical system (not shown) constituting the outer light beam radiation device 122. Further, in the second alternative embodiment, the outer light radiation range SS is arranged relative to the inner light radiation range CS such that the inner light radiation range CS is included in the outer light radiation range SS, and a rear side relative to the inner light radiation range CS in the movement direction SD, that is, a side for retaining heat of the molten pool MP (the shaped object FF), is larger than a side for preheating the base B.

Accordingly, the time for retaining the heat of the molten pool MP (the shaped object FF) can be ensured to be longer than that in the present embodiment described above. Therefore, the peak LSP1 of the power density of the outer light beam LS required for the heat retention treatment can be reduced, and for example, energy saving and manufacturing cost in additive manufacturing can be achieved, and the heat of the molten pool MP (the shaped object FF) can be retained reliably. In the second alternative embodiment, the shape of the outer light radiation range SS is an elliptical shape having a major axis in a direction along the movement direction SD. Alternatively, as indicated by long chain lines in FIG. 12, the shape of the outer light radiation range SS may be a rectangular shape having a long side in the direction along the movement direction SD. Also in this case, the same effect as that of the second alternative embodiment described above can be obtained.

### 7. Third Alternative Embodiment of Present Embodiment

In the present embodiment described above, the peaks LSP1 are the same for beam profiles of power densities of the first light beam Be1 and the second light beam Be2. For example, in a case of precisely additively manufacturing the shaped object FF, the ratio α described above is highly likely to be set to “1.5”. In this case, as shown in FIG. 10, the power density of the first light beam Be1 also increases in the present embodiment described above. For example, as in the second alternative embodiment described above, heat retention time becomes longer in a case where the outer light radiation range SS, which is a rear side relative to the inner light radiation range CS in the movement direction SD, is increased. Therefore, it is preferable that the power density of the second light beam Be2 is further reduced. In this case, it is more preferable that optical systems of the light beam radiation device 120 or beam profiles of power densities of the first light beam Be1 and the second light beam Be2 may be independently changed.

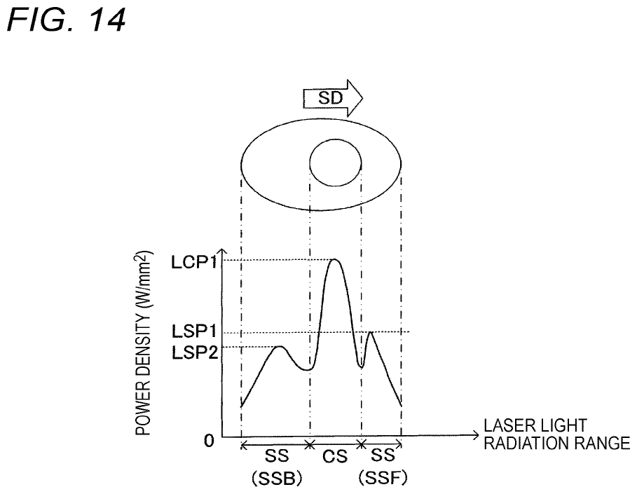

Therefore, as shown in FIGS. 13 and 14, the peak LSP1 of the beam profile of the power density of the first light beam Be1 and the peak LSP2 of the beam profile of the power density of the second light beam Be2 may be made different in accordance with a status of additive manufacturing. Accordingly, the energy required for additional manufacturing can be used efficiently, and as a result, improvement in productivity of additive manufacturing, energy saving, and cost reduction can be achieved.

### 8. Others

In the present embodiment described above, the light beam radiation device 120 is arranged coaxially with the inner light beam radiation device 121 and the outer light beam radiation device 122. In the present embodiment described above, the outer light beam irradiation device 122 radiates an annular light beam as the outer light beam LS to form the outer light radiation range SS on an outer periphery of the inner light radiation range CS formed by the inner light beam LC.

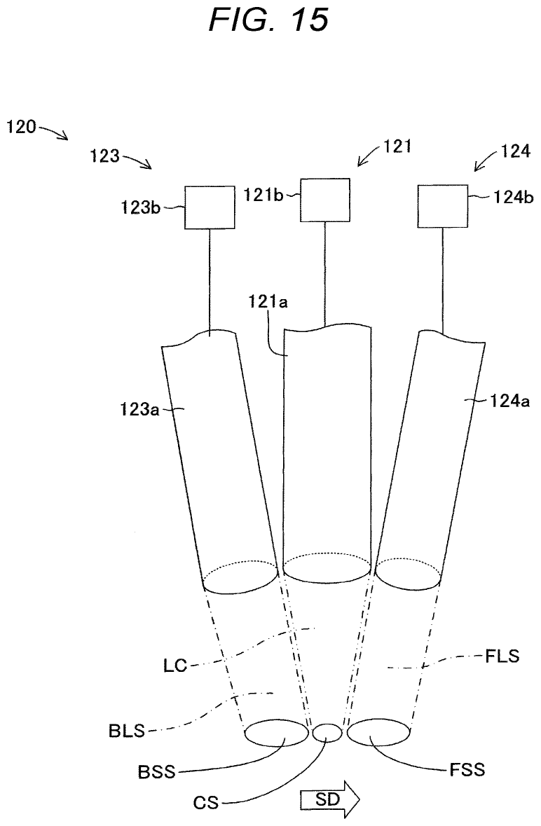

In this way, instead of the fact that the light beam radiation device 120 includes the outer light beam radiation device 122 coaxially with the inner light beam radiation device 121, and the outer light beam LS is radiated in an annular shape, the light beam radiation device 120 may be configured as shown in FIG. 15. That is, the light beam radiation device 120 may include a rear light beam radiation device 123 and a front light beam radiation device 124 as an outer light beam radiation device. The front light beam radiation device 124 may be omitted as necessary.

The rear light beam radiation device 123 mainly includes a rear light beam radiation unit 123a and a rear light beam light source 123b, and radiates a rear light beam BLS forming a rear light radiation range of a circular radiation shape on a rear side in the movement direction SD of the inner light beam LC. The front light beam radiation device 124 mainly includes a front light beam radiation unit 124a and a front light beam light source 124b, and radiates a front light beam FLS forming a front light radiation range FSS of a circular radiation shape on a front side in the movement direction SD of the inner light beam LC. Accordingly, a preheating treatment is performed as a pretreatment of a formation treatment of the molten pool MP within the front light radiation range FSS of the front light beam FLS, and a heat retention treatment is performed as a post-treatment of an additive treatment of the molten pool MP (the shaped object FF) within the rear light radiation range BSS of the rear light beam BLS.

Here, in a case where the light beam radiation device 120 is configured as shown in FIG. 15, the control device 130 controls at least movement of the rear light beam radiation device 123 so that the rear light radiation range BSS formed by the rear light beam radiation device 123 follows a path of movement of the inner light radiation range CS formed by the inner light beam radiation device 121. Accordingly, the molten pool MP (the shaped object FF) formed by the inner light beam radiation device 121 exists in the rear light radiation range BSS formed by rear light beam radiation device 123. Therefore, the rear light beam radiation device 123 can perform heat retention treatment of the molten pool MP (the shaped object FF) in the same manner as in the present embodiment described above.

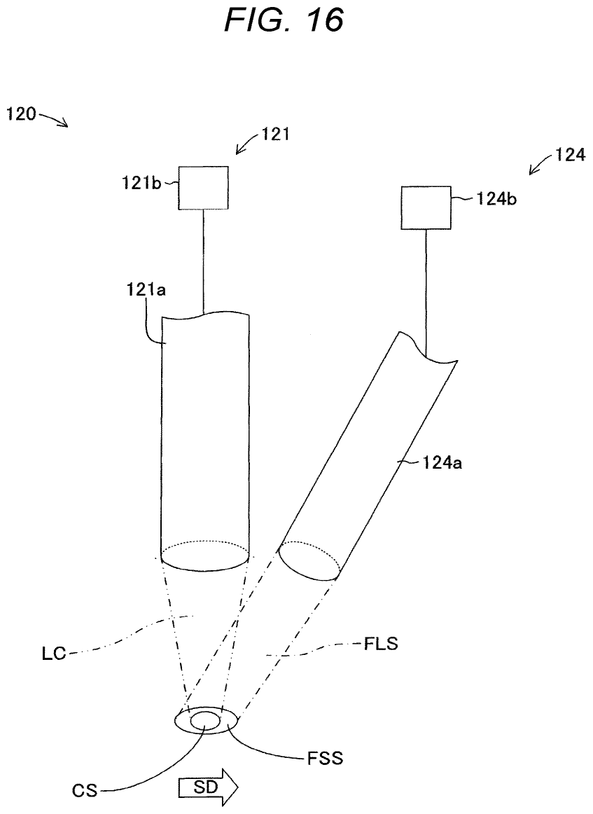

The light beam radiation device 120 may include at least one of the rear light beam radiation device 123 and the front light beam radiation device 124. Therefore, for example, in a case where the light beam radiation device 120 includes the front light beam radiation device 124, the front light radiation range FSS may also be overlapped with the inner light radiation range CS as shown in FIG. 16. That is, at least one of the rear light radiation range BSS and the front light radiation range FSS may also be overlapped with the inner light radiation range CS. In this way, two light beams are overlapped with each other, so that heat retention treatment of the molten pool MP (the shaped object FF) can be performed in the same manner as in the present embodiment described above.

In the present embodiment, the powder material formed of the hard powder material P1 and the bonded powder material P2 is ejected and supplied to the base B by the additive material supply device 110 in the additive manufacturing device 100. However, regarding material supply to the base B, the material is not limited to the powder material, and for example, a wire or the like, which is formed of linear materials made of metal, may also be supplied by an additive material supply device. In this case, a supplied linear material is melted by the inner light beam LC radiated from the light beam radiation device 120 and the heat of the linear material is retained by the outer light beam LS, so that the shaped object FF can be additively manufactured to the base B. Therefore, the same effect as that of the present embodiment can be expected.

The present embodiment or the like described above has described a case where the additive manufacturing device 100 adopts a LMD method. Alternatively, even in a case where the additive manufacturing device 100 adopts an SLM method, an outer light beam radiation device may perform heat retention by setting a cooling rate at the freezing point of cobalt (Co) to be 540° C./s or less during cooling of a molten pool (a shaped object). However, in a case where SLM is employed, a movement speed of a light beam is generally higher than a movement speed of a light beam in LMD. Therefore, in a case where the additive manufacturing device 100 adopts SLM, a movement speed of the inner light beam LC and a movement speed of the outer light beam LS are preferably lower than, for example, those during general additive manufacturing. As the movement speed is decreased, heat retention effects generated by the outer light beam LS are more exhibited.

What is claimed is:

1. An additive manufacturing device comprising:
an inner light beam radiation device configured to radiate an inner light beam that heats a material at a temperature equal to or higher than a melting point of the material, the material including tungsten carbide and a carbide binder;
an outer light beam radiation device configured to radiate an outer light beam that heats the material at a temperature lower than the melting point in an outside of the inner light beam; and
a control device configured to control radiations of the inner light beam and the outer light beam, and to control each movement of the inner light beam and the outer light beam relative to a base, for each of the inner light beam radiation device and the outer light beam radiation device,
wherein the control device is configured to:
control the inner light beam radiation device to form a molten pool by irradiating the material with the inner light beam to melt the material; and
control the outer light beam radiation device to irradiate the molten pool with the outer light beam with a power density of the outer light beam representing an output per unit area such that a cooling rate of the molten pool representing a temperature drop per unit time is 540° C./s or less at a freezing point of the carbide binder included in the molten pool and heat retention in an object to be formed is greater than or equal to 600° C.,
wherein the outer light beam is radiated in an elliptical shape having a major axis along the direction in which the outer light beam is moved, and
wherein when the inner light radiation range of the inner light beam is included in the outer light radiation range of the outer light beam, the outer light beam is radiated in the elliptical shape such that a rear side of the outer light radiation range is longer than a front side of the outer light radiation range in the direction in which the inner light beam is moved.

2. The additive manufacturing device according to claim 1, wherein a length of an outer light radiation range of the outer light beam in a direction in which the outer light beam is moved is 1.5 times or more than a length of an inner light radiation range of the inner light beam in a direction in which the inner light beam is moved.

3. The additive manufacturing device according to claim 1, wherein the control device changes at least the power density of the outer light beam, based on the temperature of the material on the base.

4. The additive manufacturing device according to claim 1, further comprising:
an additive material supply device that ejects to supply a powder material of the material to the base, the additive material supply device being controlled with the control device,
wherein the inner light beam radiation device radiates the inner light beam to the powder material which the additive material supply device supplies to the base to melt the powder material, and
wherein the outer light beam radiation device radiates the outer light beam to the molten pool formed by irradiating the powder material with the inner light beam to melt the powder material.

5. The additive manufacturing device according to claim 1, wherein the control device controls the movement of the outer light beam radiated from the outer light beam radiation device so as to follow a path of the movement of the inner light beam radiated from the inner light beam radiation device.

6. The additive manufacturing device according to claim 1, wherein the control device controls at least the power density of the outer light beam within a rear side of the outer light radiation range in the direction in which the inner light beam is moved.

7. The additive manufacturing device according to claim 1, wherein a melting point of tungsten carbide is higher than a melting point of the carbide binder.

8. The additive manufacturing device according to claim 1, wherein the carbide binder is cobalt.

9. The additive manufacturing device according to claim 1, wherein the inner light beam and the outer light beam are non-coaxial, and the inner light radiation range of the inner light beam is included in the outer light radiation range of the outer light beam.
